(19) United States
(12) Patent Application Publication
(10) Pub. No.: US 2006/0251447 A1
(43) Pub. Date: Nov. 9, 2006

(54) Image forming apparatus

(75) Inventor: Chung-guk Baek, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/356,118

(22) Filed: Feb. 17, 2006

(30) Foreign Application Priority Data
May 9, 2005 (KR) 2005-38380

(51) Int. Cl. G03G 15/02; G03G 21/18

(52) U.S. Cl. 399/111; 399/176

(57) ABSTRACT

An image forming apparatus is provided including a developer comprising a pressurizing device which moves a charging roller into contact with a photosensitive medium when mounting a developer on a main body and separates the charging roller from the photosensitive medium when separating the developer from the main body.

### CROSS-REFERENCE TO RELATED PATENT APPLICATION

This application claims the benefit under 35 U.S.C. § 119(a) of Korean Patent Application No. 10-2005-0038380, filed on May 9, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an image forming apparatus including a charging roller which charges a photosensitive medium to a predetermined potential.

2. Description of the Related Art

In general, an image forming apparatus receives a digital image signal corresponding to a desired image. Then, the image forming apparatus forms an electrostatic latent image on a photosensitive body by an exposing unit such as a laser scanning unit (LSU) and develops the electrostatic latent image using a toner to form a toner image. Next, the image forming apparatus transfers the toner image onto a recording medium and fixes the toner image onto the recording medium with high temperature and high pressure. Thus, the desired image is formed.

Image forming apparatuses are typically classified into wet type image forming apparatuses and dry type image forming apparatuses according to states of the toner and a carrier. A wet type image forming apparatus is also classified into an image forming apparatus having a one-phase developer and an image forming apparatus having a two-phase developer.

While the one-phase developer supplies only the toner to form an image, the two-phase developer supplies the carrier mixed with the toner to form an image.

In the one-phase developer, the toner is supplied to a photosensitive medium to form the toner image and then the toner remaining on the surface of the photosensitive medium is removed by a cleaning device such as a cleaning blade and collected by a collecting device such that the toner can be reused.

Meanwhile, in the two-phase developer, the carrier is not supplied to the photosensitive medium and collected, only the toner is supplied to the photosensitive medium to form the toner image. The toner remaining on the surface of the photosensitive medium is removed by a cleaning blade and collected by a collecting device such that the toner can be reused.

The aforementioned description is limited to cases of forming a monochromic (black) image. In the case of forming a multi-color image, the image remaining on the surface of the photosensitive medium is mixed with the various color toners. Consequently, it is difficult to reuse the toner.

These image forming apparatuses include a charging unit for charging the surface of the photosensitive medium to a predetermined potential. The charging unit includes a charger or a charging roller.

In the case of using the charging roller, the charging roller is pressurized with a predetermined pressure to closely adhere to the surface of the photosensitive medium. Therefore, the potential of the photosensitive medium can be uniformly maintained. Generally, both ends of the charging roller are pressurized by a spring.

The charging roller is maintained in a state where it closely adheres to the photosensitive medium with predetermined pressure. When the charging roller is left in this state for a long time, the charging roller which is typically made of rubber and the photosensitive medium react with each other to generate a pressed mark on the surface of the charging roller or the surface of the photosensitive medium. The pressed mark periodically generates an abnormal band in the charging roller or the photosensitive medium when forming the image and thus reduces image quality.

Accordingly, there is a need for an improved image forming apparatus which enhances image quality by preventing a mark from forming on the charging roller or the photosensitive medium.

### SUMMARY OF THE INVENTION

An aspect of the embodiments of the present invention is to address at least the above problems and/or disadvantages and to provide at least the advantages described below. Accordingly, an aspect of the embodiments of the present invention is to provide an image forming apparatus which moves a charging roller into contact with a photosensitive medium after mounting a developer on a main body and separates the charging roller from the photosensitive medium when separating the developer from the main body to prevent a pressed mark from being generated in the charging roller or the photosensitive medium due to long-time contact therebetween.

According to an aspect of the present invention, there is provided an image forming apparatus including a developer comprising a photosensitive medium and a charging roller which charges the photosensitive medium to a predetermined potential. The image forming apparatus comprises a pressurizing device which moves the charging roller into contact with the photosensitive medium when mounting the developer on a main body and separates the charging roller from the photosensitive medium when separating the developer from the main body.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, and features, and advantages of certain exemplary embodiments of the present invention will be more apparent from the following description taken in conjunction with the accompanying drawings, in which:

FIG. 1 is a longitudinal cross-sectional view schematically illustrating an image forming apparatus including a developer having a pressurizing device according to an embodiment of the present invention;

FIG. 2 is a longitudinal cross-sectional view of the developer shown in FIG. 1;

FIG. 3 is a partial perspective view of the developer shown in FIG. 2;

FIG. 4 is a partial perspective view illustrating a portion of the pressurizing device shown in FIG. 2;

FIG. 5 is a partial cross-sectional view of the pressurizing device in a state that the developer is not mounted on a main body according to an embodiment of the present invention; and

FIG. 6 is a partial cross-sectional view illustrating an operation when the developer is mounted on the main body according to an embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

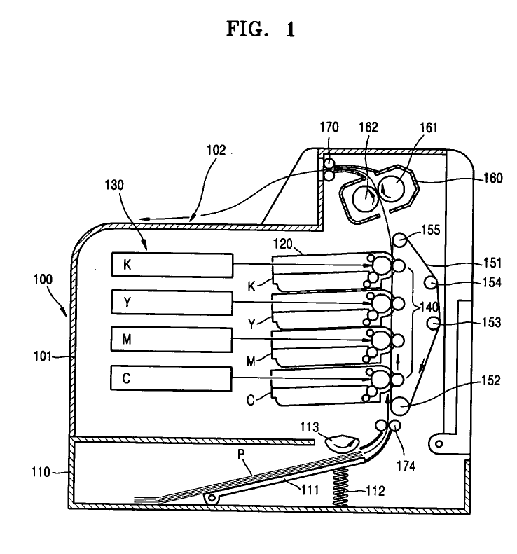

Referring to FIG. 1, an image forming apparatus 100 prints an image on a recording medium P by an electrophotographic process, and includes a cassette 110 which is detachably provided at a lower side of a main body 101 and loads a plurality of recording media P therein.

The cassette 110 is elastically biased upwardly by a spring 112 and includes a paper supporting tray 111 on which the recording medium P is loaded. A pickup roller 113 picks up the recording medium P via rotation and is provided above the cassette 110.

The image forming apparatus 100 includes a developer 120, an exposing unit 130, transfer rollers 140, a conveying belt 151, a fixing unit 160, and a discharging unit 170.

The developer 120 stores toner and supplies the toner to an electrostatic latent image corresponding to a print signal to form a toner image. The developer 120 includes a plurality of developing units 120C, 120M, 120Y, and 120K for storing a plurality of toners of cyan, magenta, yellow, and black, respectively.

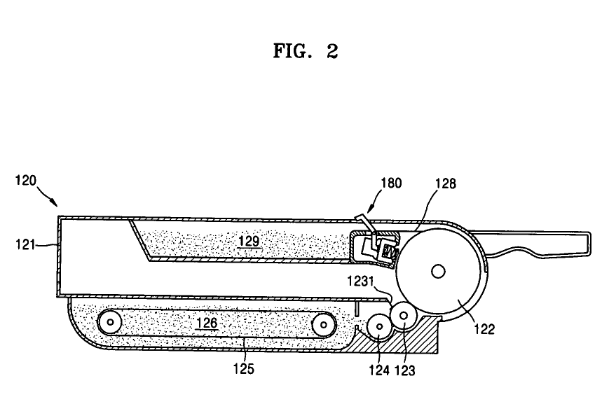

The developer 120 is detachably provided in the main body 101 as shown in FIG. 2. The developer 120 includes a photosensitive drum 122, a developing roller 123, a supplying roller 124, a toner conveying unit 125, a charging roller 127, a cleaning blade 128, and a pressurizing device 180 surrounded by a developer housing 121.

An electrostatic latent image corresponding to an image is formed on the photosensitive drum 122 by the exposing unit 130 and developed using the toner to form the toner image.

The developing roller 123 rotates in contact with the photosensitive drum 122 and supplies the toner to the electrostatic latent image to form the toner image. A metering blade 1231 for adjusting a thickness of the toner to a predetermined value is provided on the outer circumferential surface of the developing roller 123.

The supplying roller 124 supplies the toner to the developing roller 123. The toner conveying unit 125 rotates in a toner storing unit 126 in which the toner is stored and conveys the toner to the supplying roller 124.

The charging roller 127 is rotatably provided in the developer housing 121 and charges the surface of the photosensitive drum 122 to a predetermined potential.

The cleaning blade 128 removes waste toner remaining on the surface of the photosensitive drum 122 after the toner image is transferred onto the recording medium P. The waste toner is stored in a waste toner storing unit 129.

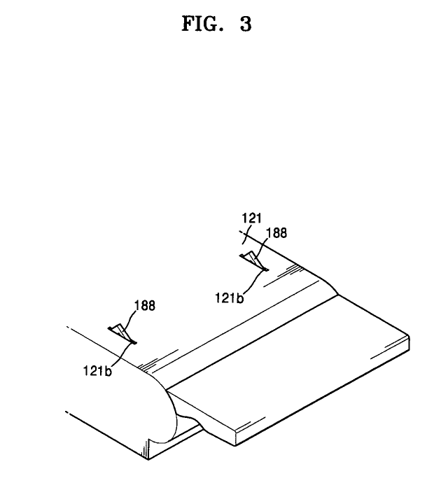

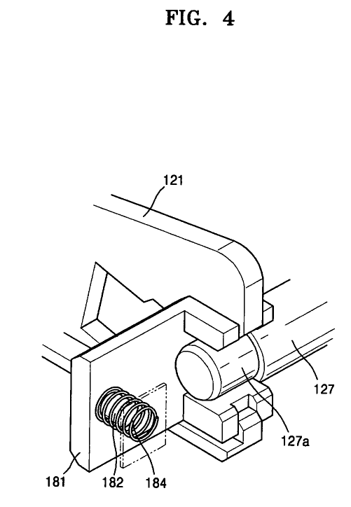

As shown in FIGS. 2 through 6, the pressurizing device 180 brings the charging roller 127 into contact with the photosensitive drum 122 when mounting the developer 120 on the main body 101 and separates the charging roller 127 from the photosensitive drum 122 when separating the developer 120 from the main body 101. The pressurizing device 180 can be provided on both sides of the photosensitive drum 122 and includes a supporting member 181 and a rotating member 185.

The supporting member 181 is slidably arranged in the developer housing 121 and rotatably supports a rotary shaft 127a of the charging roller 127. A fixing protrusion 182 for fixing one end of a spring 184 is provided on one surface of the supporting member 181, that is, a surface of the supporting member 181 facing the photosensitive drum 122.

Since one end of the spring 184 is supported by one side of the developer housing 121, an elastic force is applied to the supporting member 181 in a direction which is spaced from the photosensitive drum 122.

The rotating member 185 is provided in the developer housing 121 such that it rotates around the rotary shaft 185 and includes a pushing unit 187 and an interfering unit 188 which form a predetermined angle.

The interfering unit 188 protrudes from a through-hole 121b provided in an upper side of the developer housing 121 and the pushing unit 187 contacts the other side 183 of the supporting member 181.

An operation of the pressurizing device 180 having the aforementioned structure will now be described with reference to the accompanying drawings.

Referring to FIGS. 2 through 5, since the elastic force of the spring 184 is applied to the supporting member 181 when the developer 120 is not mounted on the main body 101, the charging roller 127 supported by the supporting member 181 is spaced from the photosensitive drum at a predetermined interval. The pushing unit 187 contacts the other side of the supporting member 181 and the interfering unit 188 protrudes to the upper side of the developer housing 121.

Referring to FIG. 6, when mounting the developer 120 on the main body 101, the interfering unit 188 contacts a guide frame 103 which is provided in the main body 101 to guide the developer 120 so that the developer 120 can be accurately mounted on the main body 101.

The interfering unit 188 contacts the guide frame 103 and the rotating member 185 rotates around the rotary shaft 186 in a counter-clockwise direction (an arrow A direction), and the pushing unit 187 pushes the supporting member 181 in an arrow B direction.

Then, the supporting member 181 slides in the direction of arrow B. Thus, the charging roller 127 contacts the photosensitive drum 122. At this time, the spring 184 contracts via a force applied by rotation of the rotating member 185.

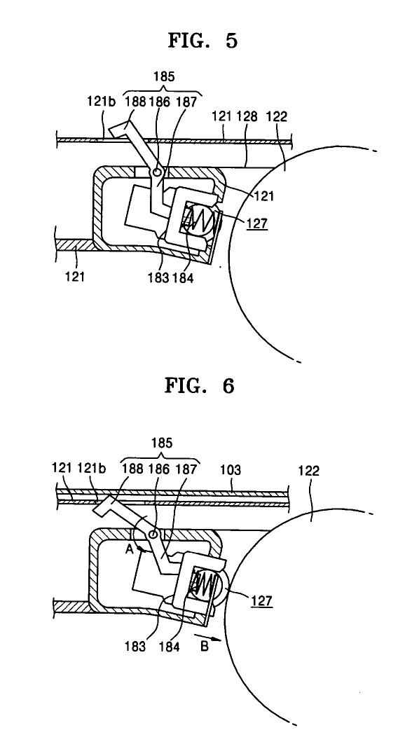

When the developer 120 separates from the main body 101, the charging roller 127 and the photosensitive drum 122 are spaced from each other, as shown in FIG. 5.

The exposing unit 130 irradiates light onto the photosensitive drum 122 to form the electrostatic latent image corresponding to the print signal and includes a plurality of exposing units 130C, 130M, 130Y, and 130K corresponding to the plurality of the developing units 120C, 120M, 120Y, and 120K, respectively.

The conveying belt 151 is supported by a plurality of rollers 152, 153, 154, and 155, and rotates around a closed loop. The conveying belt 151 conveys the recording medium P, which is picked up from the cassette 110 and conveyed by a conveying roller 174, while the recording medium P sequentially faces the developing units 120C, 120M, 120Y, and 120K.

The plurality of the transfer rollers 140 face the developing units 120C, 120M, 120Y, 120K through the conveying belt 151, respectively, and transfers the toner image formed on the photosensitive drum 121 onto the recording medium P conveyed by the conveying belt 151.

The fixing unit 160 fixes the toner image onto the recording medium P and includes a heating roller 161 for applying heat to the toner image and a pressurizing roller 162 for pressurizing the recording medium P to the heating roller 161 while contacting the heating roller 161.

The discharging unit 170 discharges the recording medium P onto which the toner image is fixed by the fixing unit 160 to the outside of the image forming apparatus. That is, a pair of rollers which face each other discharge the recording medium P onto which the toner image is fixed to the outside. The recording medium P is discharged by the discharging unit 170 and loaded on a discharging tray 102.

As mentioned above, in the image forming apparatus according to the exemplary embodiments of the present invention, since the charging roller is not in contact with the photosensitive drum in a delivering period or when idle, the development of a pressed mark can be prevented from being generated in the charging roller or the photosensitive drum. As a result, the reliability of image apparatus can be improved so that quality images are formed.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus including a developer comprising a photosensitive medium and a charging roller which charges the photosensitive medium to a predetermined potential, comprising:
a pressurizing device which moves the charging roller into contact with the photosensitive medium when mounting the developer on a main body and separates the charging roller from the photosensitive medium when separating the developer from the main body.

2. The apparatus according to claim 1, wherein the pressurizing device comprises:
a supporting member slidably arranged in a developer housing to rotatably support the charging roller; and
a rotating member rotatably arranged in the developer housing to push the supporting member toward the photosensitive medium when mounting the developer on the main body.

3. The apparatus according to claim 2, wherein the supporting member is applied with an elastic force in a direction which is spaced from the photosensitive medium by a spring and separates the charging roller from the photosensitive medium by the spring when separating the developer from the main body.

4. The apparatus according to claim 2, wherein one side of the rotating member protrudes through a through-hole provided in an upper side of the developer housing.

5. The apparatus according to claim 4, wherein the pressurizing device moves the charging roller into contact with the photosensitive medium by moving the one side of the rotating member into contact with a guide frame provided in the main frame.

6. The apparatus according to claim 2, wherein the pressurizing device is provided on both sides of the charging roller.

7. An image forming apparatus, comprising:
a developer including a photosensitive medium and a charging roller which charges the photosensitive medium to a predetermined potential; and
a pressurizing device which moves the charging roller into contact with the photosensitive medium when mounting the developer on a main body and separates the charging roller from the photosensitive medium when separating the developer from the main body, the pressurizing device comprises a supporting member slidably arranged in a developer housing to rotatably support the charging roller.

8. The apparatus according to claim 7, wherein the pressurizing device further comprises:
a rotating member rotatably arranged in the developer housing to push the supporting member toward the photosensitive medium when mounting the developer on the main body.

9. The apparatus according to claim 7, wherein the supporting member is applied with an elastic force in a direction which is spaced from the photosensitive medium by a spring and separates the charging roller from the photosensitive medium by the spring when separating the developer from the main body.

10. The apparatus according to claim 8, wherein one side of the rotating member protrudes through a through-hole provided in an upper side of the developer housing.

11. The apparatus according to claim 10, wherein the pressurizing device moves the charging roller into contact with the photosensitive medium by moving the one side of the rotating member into contact with a guide frame provided in the main frame.

12. The apparatus according to claim 7, wherein the pressurizing device is provided on both sides of the charging roller.
